(19) United States
(12) Patent Application Publication
(10) Pub. No.: US 2024/0285373 A1
(43) Pub. Date: Aug. 29, 2024

(54) DENTAL ABUTMENT CONSTRUCTION MEMBER AND PRODUCTION METHOD

(71) Applicant: National University Corporation Tokyo Medical and Dental University, Tokyo (JP)

(72) Inventors: Wataru Komada, Tokyo (JP); Shinya Oishi, Tokyo (JP)

(21) Appl. No.: 18/558,824

(22) PCT Filed: May 6, 2022
(86) PCT No.: PCT/JP2022/019557

§ 371 Date: May 10, 2024

(30) Foreign Application Priority Data
May 7, 2021 (JP) 2021-079105

(51) Int. Cl. A61C 5/35

(52) U.S. Cl. CPC A61C 5/35

(57) ABSTRACT

A dental abutment construction member which is used for the construction of abutments is configured so as to have a tubular shape having an upper surface, a bottom surface, an outer peripheral side surface and an inner peripheral side surface. According to this configuration, the concentration of stress in cervical areas can be prevented and the formation of post holes becomes unnecessary.

### TECHNICAL FIELD

The present invention relates to a dental abutment construction member which reinforces a construction body in a composite resin abutment construction, and a method of preparing.

### BACKGROUND ART

An abutment construction in which an abutment is constructed on a tooth root, and which makes the abutment support a dental crown prosthesis device in a case in which the crown of a tooth has collapsed due to progression of dental caries, or in other words, tooth decay, and only the tooth root has remained, has been known. In that abutment construction, after filling up a photocurable resin in a root canal, a post is inserted into the root canal of the tooth root, and thereafter, the post is fixed to the tooth root by hardening the photocurable resin by irradiating light. A conventional post is used for this post. In Patent Document 1, a dental fiber post having a high strength which enables hardening of the photocurable resin at a deep portion of the tooth root by using a plurality of optically transparent fibers as the post has been disclosed. An example in which abutment is formed by using a fiber post as the post is shown in FIG. 17. In FIG. 17, the abutment construction is carried out by fitting a fiber post 201 upon making a post hole, and being embedded in a composite resin 203.

In such abutment construction, it is necessary to make a post hole for inserting a post into the tooth root. While making the post hole, there was a risk of causing a perforation or a root fracture, and also there was a possibility of causing weakening of the remaining tooth substance. Furthermore, treatment for making the post hole was time consuming. With a metal post in which a material of the post is a metal, there was an issue of metal allergy.

### CITATION LIST

### Patent Documents

Patent Document 1: Japanese Patent Application Laid-open Publication No. 2019-58323

### SUMMARY OF THE INVENTION

### Problems to be Solved by the Invention

In an abutment construction, the conventional post has been used. In a conventional post fitting, there was a need to make a post hole, and there was a possibility of causing perforation while doing so. Moreover, in a case of using the conventional post, the stress, being concentrated at a cervical portion, used to cause a horizontal fracture of a crown or a tooth root, or a vertical fracture of the tooth root. Furthermore, with a metal post, there were issues such as metal allergy.

In addition, when the conventional post was used, there was an issue of time consumption for making the post hole for fitting the post.

### Means for Solving the Problems

A dental abutment construction member according to embodiment 1 is configured to have a tubular shape, and to have an upper surface, a lower surface, an outer peripheral surface, and an inner peripheral surface.

A dental abutment construction member according to embodiment 2 is the dental abutment construction member according to embodiment 1, and is configured such that each of the upper surface and the lower surface has an annular shape, and the outer peripheral surface connects an outer edge of the annular shape of the upper surface and an outer edge of the annular shape of the lower surface, and the inner peripheral surface connects an inner edge of the annular shape of the upper surface and an inner edge of the annular shape of the lower surface.

A dental abutment construction member according to embodiment 3 is the dental abutment construction member according to embodiment 2, and is configured such that the inner edge of the annular shape of the upper surface has an elliptical shape and the inner edge of the annular shape of the lower surface has an elliptical shape.

A dental abutment construction member according to embodiment 4 is the dental abutment construction member according to embodiment 3, and is configured such that an axis in a longer direction of the elliptical shape which is the inner edge of the annular shape of the upper surface and an axis in a longer direction of the elliptical shape which is the inner edge of the annular shape of the lower surface are in the same plane.

A dental abutment construction member according to embodiment 5 is the dental abutment construction member according to any one of embodiments 1 to 4, and is configured such that both the outer peripheral surface and the inner peripheral surface are flat surfaces.

A dental abutment construction member according to embodiment 6 is the dental abutment construction member according to any one of embodiments 1 to 4, and is configured such that the outer peripheral surface is an uneven surface and the inner peripheral surface is a flat surface.

A dental abutment construction member according to embodiment 7 is the dental abutment construction member according to embodiment 6, and is configured such that an uneven shape of the uneven surface of the outer peripheral surface is a screw-thread shape.

A dental abutment construction member according to embodiment 8 is the dental abutment construction member according to any one of embodiments 3 to 7, and is configured such that a length in the longer direction of the elliptical shape which is the inner edge of the annular shape of the upper surface is in a range including both ends of a range from 0.5 mm to 9 mm, a length in a short direction of the elliptical shape which is the inner edge of the annular shape of the upper surface is in a range including both ends of a range from 0.5 mm to 9 mm, a length in the longer direction of the elliptical shape which is the inner edge of the annular shape of the lower surface is in a range including both ends of a range from 0.5 mm to 9 mm, and a length in the short direction of the elliptical shape which is the inner edge of the annular shape of the lower surface is in a range including both ends of a range from 0.5 mm to 9 mm, and a width in a horizontal plane of the outer peripheral surface is in a range including both ends of a range from 1.5 mm to 10 mm,
a thickness of a wall formed by the outer peripheral surface and the inner peripheral surface is at least 0.5 mm, and
a height of the dental abutment construction member is in a range including both ends of a range from 2 mm to 10 mm.

A dental abutment construction member according to embodiment 9 is the dental abutment construction member according to embodiment 1, and is configured such that each of the upper surface and the lower surface has an annular shape, and in between the upper surface and the lower surface, there is an intermediate surface which separates the upper surface and the lower surface, and the outer peripheral surface connects an outer edge of the annular shape of the upper surface and an outer edge of the annular shape of the lower surface, and the inner peripheral surface connects an inner edge of the annular shape of the upper surface and an edge which the inner peripheral surface and an upper-side surface of the intermediate surface connect, and is also connects an inner edge of the annular shape of the lower surface and an edge which the inner peripheral surface and a lower-side surface of the intermediate surface connect.

A dental abutment construction member according to embodiment 10 is the dental abutment construction member according to embodiment 9, and is configured such that the inner edge of the annular shape of the upper surface has an elliptical shape and the inner edge of the annular shape of the lower surface has an elliptical shape.

A dental abutment construction member according to embodiment 11 is the dental abutment construction member according to embodiment 10, and is configured such that an axis in a longer direction of the elliptical shape which is the inner edge of the annular shape of the upper surface and an axis in a longer direction of the elliptical shape which is the inner edge of the annular shape of the lower surface are in the same plane.

A dental abutment construction member according to embodiment 12 is the dental abutment construction member according to any one of embodiments 9 to 11, and is configured such that both the outer peripheral surface and the inner peripheral surface are flat surfaces.

A dental abutment construction member according to embodiment 13 is the dental abutment construction member according to any one of embodiments 9 to 11, and is configured such that the outer peripheral surface is an uneven surface and the inner peripheral surface is a flat surface.

A dental abutment construction member according to embodiment 14 is the dental abutment construction member according to embodiment 13, and is configured such that an uneven shape of the uneven surface of the outer peripheral surface is a screw-thread shape.

A dental abutment construction member according to embodiment 15 is the dental abutment construction member according to any one of embodiments 10 to 14, and is configured such that a length in a longer direction of the elliptical shape which is the inner edge of the annular shape of the upper surface is in a range including both ends of a range from 0.5 mm to 9 mm, a length in a short direction of the elliptical shape which is the inner edge of the annular shape of the upper surface is in a range including both ends of a range from 0.5 mm to 9 mm, a length in the longer direction of the elliptical shape which is the inner edge of the annular shape of the lower surface is in a range including both ends of a range from 0.5 mm to 9 mm, and a length in the short direction of the elliptical shape which is the inner edge of the annular shape of the lower surface is in a range including both ends of a range from 0.5 mm to 9 mm, and a thickness in a vertical direction of the intermediate surface is in a range including both ends of a range from 0.5 mm to 4.5 mm, and the upper-side surface of the intermediate surface is positioned at a position in a range including both ends of a range from 1.5 mm to 5 mm, and a width in a horizontal plane of the outer peripheral surface is in a range including both ends of a range from 1.5 mm to 10 mm, and a thickness of a wall formed by the outer peripheral surface and the inner peripheral surface is at least 0.5 mm, and a height of the dental abutment construction member is in a range including both ends of a range from 2 mm to 10 mm.

A dental abutment construction member according to embodiment 16 is the dental abutment construction member according to any one of embodiments 3 to 5 or embodiments 10 to 12, and is configured such that an outer edge of the annular shape of the upper surface has an elliptical shape and an outer edge of the annular shape of the lower surface has an elliptical shape, and the dental abutment construction member has an outer diameter at which each of the length in the longer direction of the elliptical shape formed by the outer edge of the annular shape of the upper surface, the length in the short direction of the elliptical shape which is the outer edge of the annular shape of the upper surface, the length in the longer direction of the elliptical shape which is the outer edge of the annular shape of the lower surface, and the length in the short direction of the elliptical shape which is the outer edge of the annular shape of the lower surface is the same length, and the dental abutment construction member has an inner diameter at which each of the length in the longer direction of the elliptical shape formed by the inner edge of the annular shape of the upper surface, the length in the short direction of the elliptical shape which is the inner edge of the annular shape of the upper surface, the length in the longer direction of the elliptical shape which is the inner edge of the annular shape of the lower surface, and the length in the short direction of the elliptical shape which is the inner edge of the annular shape of the lower surface is the same length.

A dental abutment construction member according to embodiment 17 is the dental abutment construction member according to embodiment 16, and is configured such that the outer diameter is in a range including both ends of a range from 1.5 mm to 10 mm, and the inner diameter is in a range including both ends of a range from 0.5 mm to 9 mm, and a thickness of a wall formed by the outer peripheral surface and the inner peripheral surface is at least 0.5 mm, and a height of the dental abutment construction member is in a range including both ends of a range from 2 mm to 10 mm.

A dental abutment construction member according to embodiment 18 is the dental abutment construction member according to any one of embodiments 3 to 8 or embodiments 10 to 15, and is configured such that the length in the longer direction of the elliptical shape forming the inner edge of the annular shape of the upper surface is longer than the length in the longer direction of the elliptical shape forming the inner edge of the annular shape of the lower surface, and the length in the short direction of the elliptical shape forming the inner edge of the annular shape of the upper surface is longer than the length in the short direction of the elliptical shape forming the inner edge of the annular shape of the lower surface.

A dental abutment construction member according to embodiment 19 is the dental abutment construction member according to any one of embodiments 3 to 8 or embodiments 10 to 15, and is configured such that the dental abutment construction member has a diameter of an upper-surface inner edge at which the length in the longer direction of the elliptical shape which is the inner edge of the annular shape of the upper surface and the length in the short direction of the elliptical shape which is the inner edge of the annular shape of the upper surface are same, and the dental abutment construction member has a diameter of a lower-surface inner edge at which the length in the longer direction of the elliptical shape which is the inner edge of the annular shape of the lower surface and the length in the short direction of the elliptical shape which is the inner edge of the annular shape of the lower surface are same, and a diameter of the upper-surface inner edge is larger than a diameter of the lower-surface inner edge.

A dental abutment construction member according to embodiment 20 is the dental abutment construction member according to any one of embodiments 1 to 19, and is configured such that at least a part of a surface of the dental abutment construction member has a rough surface.

A dental abutment construction member according to embodiment 21 is the dental abutment construction member according to any one of embodiments 1 to 20, and is configured such that the dental abutment construction member is formed of a material which includes ceramic.

A dental abutment construction member according to embodiment 22 is the dental abutment construction member according to embodiment 21, and is configured such that the ceramic includes a material selected from alumina-toughened zirconia, ceria-stabilized alumina-toughened zirconia, 3 mol % yttria-partially stabilized zirconia, 4 mol % yttria partially stabilized zirconia, 5 mol % yttria partially stabilized zirconia, 6 mol % yttria partially stabilized zirconia, yttria-partially stabilized zirconia composite, alumina, lithium disilicate, and zirconia-toughened lithium disilicate.

A dental abutment construction member according to embodiment 23 is the dental abutment construction member according to any one of embodiments 1 to 22, and is configured to be used by being embedded in a composite resin in an abutment construction of a target tooth for which the dental abutment construction is used.

A dental abutment construction member according to embodiment 24 is the dental abutment construction member according to any one of embodiments 1 to 23, and is configured to be used by being disposed such that a vertical direction of the dental abutment construction member is directed in a direction from a root of a target tooth toward a crown of the target tooth for which the dental abutment construction member is used.

A dental abutment construction member according to embodiment 25 is the dental abutment construction member according to any one of embodiments 1 to 24, and is configured to be embedded in a composite resin such that the dental abutment construction member is not in contact with a tooth substance inside an abutment construction cavity of the target tooth for which the dental abutment construction member is used.

A method of preparing dental abutment construction member according to embodiment 26 by using a material for preparing which includes at least a material selected from ceramic, alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate, and zirconia-toughened lithium disilicate, is configured to include forming a member which matches with a shape of the dental abutment construction member according to any one of embodiments 1 to 20.

A method of preparing dental abutment construction member according to embodiment 27 by cutting a base material in which a material for preparing which includes at least a material selected from ceramic, alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate and zirconia-toughened lithium disilicate is used, is configured to include preparing the base material, and preparing a member which matches with a shape of the dental abutment construction member according to any one of embodiments 1 to 20 by machining the base material.

A method of preparing dental abutment construction member according to embodiment 28 is configured to include arranging a casting mold which matches with a shape of the dental abutment construction member according to any one of claims 1 to 20, pouring a material which includes at least a glass ceramics material into the casting mold, and pressurizing the material poured.

A method of preparing dental abutment construction member according to embodiment 29 by a 3D (3-dimensional) printing apparatus by using a material for preparing which includes at least a material selected from ceramic, alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate, and zirconia-toughened lithium disilicate, is configured to include creating shape data for the 3D printing apparatus to prepare a member having a shape of the dental abutment construction member according to any one of embodiments 1 to 20, inputting the shape data to the 3D printing apparatus, and preparing a member which matches with the shape of the dental abutment construction member by putting the 3D printing apparatus into operation.

A method of dental treatment according to embodiment 30 is configured to include setting the dental abutment construction member according to any one of embodiments 1 to 25 in an abutment construction cavity of a target tooth, constructing an abutment by embedding the dental abutment construction member in a composite resin, and putting a crown on the target tooth for which the abutment is constructed.

### Effect of the Invention

According to the present invention, there is provided a dental abutment construction member which is a tubular structure that reinforces a cervical portion which is a part subjected to stress concentration by a composite resin abutment construction. As a result, it is possible to reinforce the cervical portion which is a part subjected to stress concentration by the composite resin abutment construction, by the dental abutment construction member according to the present invention, and to construct a strong abutment by integrating a construction body and a tooth root.

Moreover, according to the present invention, as there is no need to make a post hole in the abutment concentration, it is possible to reduce a risk of causing a perforation or a risk of a tooth root fracture, and to prevent weakening of the remaining tooth substance. Furthermore, there being no need to make the post hole, it is possible to facilitate shortening of treatment time.

### BRIEF DESCRIPTION OF THE DRAWINGS

FIG. 1 is an example of a dental abutment construction member according to a first embodiment,

FIG. 2 is another example of the dental abutment construction member according to the first embodiment;

FIG. 3 is still another example of the dental abutment construction member according to the first embodiment;

FIG. 4 is still another example of the dental abutment construction member according to the first embodiment;

FIG. 5 is an example of a dental abutment construction member according to a second embodiment;

FIG. 6 is an example of a dental abutment construction member according to a third embodiment;

FIG. 7 is an example of a dental abutment construction member according to a fourth embodiment;

FIG. 8 is a schematic diagram of an abutment construction in which a dental abutment construction member according to the present invention has been used:

FIG. 9 is an example of a prototype;

FIG. 10 is an interior of a treated tooth for which the prototype was used;

FIG. 11 is a comparison example 1 (crown—buccal side) of a core to which the present invention was applied and a conventional core:

FIG. 12 is a comparison example 1 (tooth root—buccal side) of a core according to the present invention and a conventional core;

FIG. 13 is a comparison example 1 (tooth root—lingual side) of a core according to the present invention and a conventional core;

FIG. 14 is a comparison example 2 (crown—buccal side) of a core according to the present invention and a conventional core;

FIG. 15 is a comparison example 2 (crown—lingual side) of a core according to the present invention and a conventional core;

FIG. 16 is a comparison example 2 (tooth root—lingual side) of a core according to the present invention and a conventional core; and

FIG. 17 is a schematic diagram of an abutment construction in which a conventional fiber post core was used.

### MODE FOR CARRYING OUT THE INVENTION

Embodiments of a dental abutment construction member and a method of preparing dental abutment construction member according to the present invention will be described below while referring to diagrams. All the embodiments described below are embodiments indicating preferred specific examples of the present invention. Therefore, numerical values, shapes, materials, components, positions at which the components are disposed, modes of connection, process, and order of process etc. are mere examples and do not restrict the present invention.

Moreover, each diagram is a schematic diagram, and is not necessarily an exact illustration. Repetitive description of diagrams will be omitted or simplified.

Regarding a treatment for caries, or in other words, tooth decay, in a case of making a composite resin abutment construction, a process will be carried out by the following process for example.
(1) root canal treatment, (2) resin abutment construction, (3) putting on crown

For the resin abutment construction, a method of constructing an abutment with a composite resin only and without using a post, a method in which a metal post is combined and a method in which a fiber post is combined, have been known as conventional methods.

In these conventional methods, stress being concentrated on a cervical portion, used to cause a horizontal fracture of a tooth crown and a tooth root or a vertical fracture of a tooth root. Moreover, there was a possibility of causing a perforation at the time of making a post hole. Furthermore, in the method in which a metal post is combined, there had been issues such as that of metal allergy.

The inventors of the present invention, invented a dental abutment construction member to be used in a novel abutment construction that would replace these conventional abutment constructions in a resin abutment construction. Embodiments of the dental abutment construction member according to the present invention will be described below in detail.

### First Embodiment

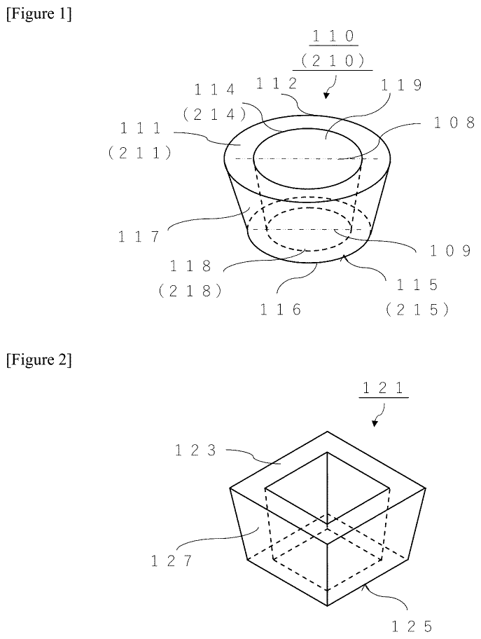

A first embodiment of the present invention will be described below. An example of the first embodiment is shown in FIG. 1 as a first aspect. In this example, a dental abutment construction member 110 according to a first aspect of the first embodiment is configured to be tubular-shaped, and to have an upper surface 111, a lower surface 115, and an outer peripheral surface 117. In this example, the tube is configured to be circular cylindrical shaped.

The dental abutment construction member 110 is a member to be used by being embedded in a composite resin inside an abutment construction cavity in a composite resin abutment construction.

The dental abutment construction member 110, by being configured as described above, it is possible to reinforce the cervical portion which is a part on which the stress of the composite resin abutment construction is concentrated, by the tubular shaped dental abutment construction member 110. Consequently, it is possible to reinforce the cervical portion which is a part on which the stress of the composite resin abutment construction is concentrated, by the dental abutment construction member according to the present invention, and to construct a strong abutment by integrating a construction body and a tooth root.

More specifically, when a force is applied to a tooth treated by using the dental abutment construction member 110, the dental abutment construction member 110 being tubular-shaped and having the upper surface 111, the lower surface 115, and the outer peripheral surface 117, may act such that the force applied is distributed by the overall tube because of the tubular shape, without being applied to one particular portion inside the tooth. Consequently, it is possible to reduce a risk of causing a fracture of a tooth root treated by using the dental abutment construction member 110. Moreover, for the dental abutment construction member 110, there is no need to make a post hole as in a case of using a fiber post, thereby making it possible to reduce a risk of causing perforation or a fracture of the tooth root, and to prevent weakening of the remaining tooth substance. Furthermore, there being no need to make a post hole, it is possible to facilitate shortening of treatment time.

Another example of the first embodiment is shown in FIG. 2. Unlike as shown in FIG. 1, a dental abutment construction member 121 as shown in FIG. 2 may have a tubular shape with a horizontal cross-section thereof being quadrangular-shaped. Here, this is an example in which an upper surface 123 and a lower surface 125 have a quadrangular shape, and an outer peripheral surface 127 is made of four flat surfaces. Furthermore, the dental abutment construction member may be a member having various horizontal cross-sectional shapes such as a triangular shape. Even with these shapes, the dental abutment construction member has advantageous effects described in the example of the circular cylindrical shape.

The dental abutment construction member according to the first embodiment can also be configured as a second aspect of the first embodiment as described below. In other words, the second aspect of the first embodiment in FIG. 1 is the dental abutment construction member 110 described in the abovementioned first aspect of the first embodiment, and is configured such that the upper surface 111 and the lower surface 115 form annular shapes 211 and 215 respectively, the outer peripheral surface 117 connects an outer edge 112 of the annular shape 211 of the upper surface 111 and an outer edge 116 of the annular shape 215 of the lower surface 115, and an inner peripheral surface 119 connects an inner edge 114 of the annular shape 211 of the upper surface 111 and an inner edge 118 of the annular shape 215 of the lower surface 115. Even by making such configuration, the abovementioned advantageous effects are exerted. When such annular shape is adopted, there is an effect that demolding in a method of preparing dental abutment construction member using a mold becomes easy.

Furthermore, the dental abutment construction member according to the first embodiment can also be configured as a third aspect of the first embodiment as described below. In other words, the third aspect of the first embodiment in FIG. 1 is the dental abutment construction member 110 of the second aspect of the first embodiment, and is configured such that the inner edge 114 of the annular shape 211 of the upper surface 111 is an elliptical shape 214, and the inner edge 118 of the annular shape 215 of the lower surface 115 is an elliptical shape 218.

By making such configuration, there is an advantage of ease of matching with a tooth having the abovementioned elliptical shape which is longer in the longer direction.

Furthermore, the dental abutment construction member according to the first embodiment can also be configured as a fourth aspect of the first embodiment as described below. In other words, the fourth aspect of the first embodiment in FIG. 1 is a dental abutment construction member 210 according to the third aspect of the first embodiment, and is configured such that an axis 108 in a longer direction of the elliptical shape 214 which is an inner edge of the annular shape of the upper surface 111 and an axis 109 in a longer direction of the elliptical shape 218 which is the inner edge 118 of the annular shape 215 of the lower surface 115 are in the same plane.

By making a configuration such that the axis 108 in the longer direction of the elliptical shape 214 and the axis 109 in the longer direction of the elliptical shape 218 are in the same plane surface, it is easy to match the dental abutment construction member according to the present invention with the tooth having the abovementioned elliptical shape which is longer in the longer direction, and the demolding at the time of preparation by using a mold becomes easy, thereby the preparation of the member becoming easy.

Furthermore, the dental abutment construction member according to the first embodiment can also be configured as a fifth aspect of the first embodiment. In other words, the first fifth aspect of the first embodiment, in FIG. 1, is the dental abutment construction member according to any one of the aspects from the first aspect of the first embodiment to the fourth aspect of the first embodiment, and is configured such that both the outer peripheral surface 117 and the inner peripheral surface 119 are flat surfaces. The flat surface, for example, refers to a surface for which an unevenness, or a difference in a high and a low level is less than 0.25 mm in the present application. By making the outer peripheral surface 117 and the inner peripheral surface 119 flat surfaces, the dental abutment construction member according to the present invention can be prepared easily.

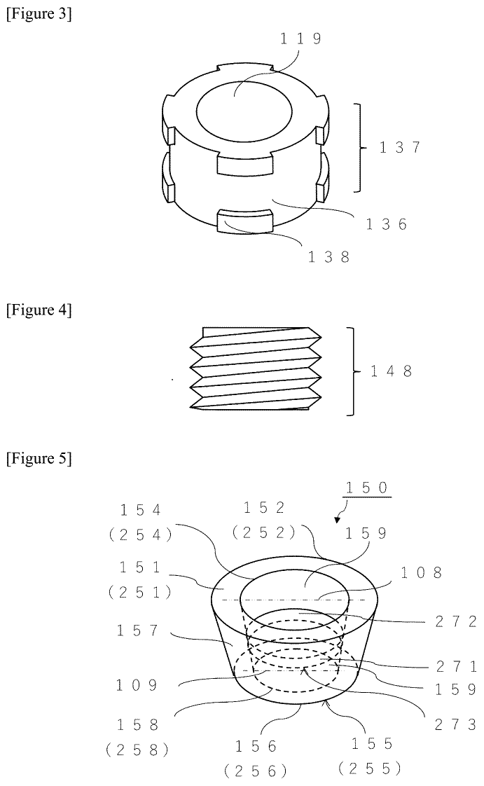

Furthermore, the dental abutment construction member according to the first embodiment can also be configured as a sixth aspect of the first embodiment as described below. In other words, the sixth aspect of the first embodiment, as shown in FIG. 3, is the dental abutment construction member according to any one of the aspects from the first aspect of the first embodiment to the fourth aspect of the first embodiment, and is configured such that an outer peripheral surface 137 is an uneven surface, and the inner peripheral surface 119 is a flat surface. A recess portion 136 and a protruding portion 138 are examples of unevenness of the outer peripheral surface 137.

By providing unevenness to the outer peripheral surface, the dental abutment construction member is attached more firmly to the composite resin in which it is embedded at the time of abutment construction, and it is possible to make it a strong abutment.

Furthermore, the dental abutment construction member according to the first embodiment can also be configured as a seventh aspect of the first embodiment as described below. In other words, the seventh aspect of the first embodiment, as shown in FIG. 4, can also be configured as another example of the sixth aspect of the first embodiment as described below. In other words, the seventh aspect of the first embodiment is the dental abutment construction member of the sixth aspect of the first embodiment, and is configured such that the uneven shape of the uneven surface of the outer peripheral surface is a screw-thread shape 148.

Thus, even by making a configuration such that the uneven shape of the uneven surface of the outer peripheral surface is the screw-thread shape 148, the dental abutment construction member is attached more firmly to the composite resin in which it is embedded at the time of abutment construction, and it is possible to make it a strong abutment.

Furthermore, the uneven shape of the outer peripheral surface can also take various shapes other than the screw-thread shape. For instance, the various shapes include shapes such as a pyramid-like protruding shape, a protruding shape having a part of a sphere, a protruding shape of a rugged rock which does not have a regular shape. Moreover, the uneven shape of the outer peripheral surface may be formed as a recess having pyramid-like shape, a shape having a part of a sphere, or a shape of a rugged rock which does not have a regular shape, on the outer peripheral surface. These shapes also have the abovementioned advantageous effects.

Furthermore, the dental abutment construction member according to the first embodiment can also be configured as an eighth aspect of the first embodiment as described below. In other words, the eighth aspect of the first embodiment, in FIG. 1 for instance, is the dental abutment construction member according to any one of the aspects from the third aspect of the first embodiment to the seventh aspect of the first embodiment, and is configured such that a length in the longer direction of the elliptical shape 214 which is the inner edge of the annular shape of the upper surface 111 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a length in a short direction of the elliptical shape 214 which is the inner edge of the annular shape of the upper surface 111 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a length in the longer direction of the elliptical shape 218 which is the edge 118 of the annular shape 215 of the lower surface 115 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a length in a short direction of the elliptical shape 218 which is the inner edge 118 of the annular shape 215 of the lower surface 115 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a width in a horizontal plane of the outer peripheral surface 117 is in a range including both ends of a range from 1.5 mm to 10 mm, for example, 1.5 mm or more, 2 mm or more, 3 mm or more, 4 mm or more, 5 mm or more, 6 mm or more, 7 mm or more, 8 mm or more, or 9 mm or more, and 10 mm or less, 9 mm or less, 8 mm or less, 7 mm or less, 6 mm or less, 5 mm or less, 4 mm or less, 3 mm or less, or 2 mm or less, and a thickness of a wall formed by the outer peripheral surface 117 and the inner peripheral surface 119 is at least 0.5 mm, for example, 0.5 mm or more, 0.6 mm or more, 0.7 mm or more, 0.8 mm or more, 0.9 mm or more, 1 mm or more, 1.5 mm or more, 2 mm or more, or 2.5 mm or more, and 3 mm or less, 2.5 mm or less, 2 mm or less, 1.5 mm or less, 1 mm or less, 0.9 mm or less, 0.8 mm or less, 0.7 mm or less, or 0.6 mm or less, and a height of the dental abutment construction member is in a range including both ends of a range from 2 mm to 10 mm, for example, 2 mm or more, 3 mm or more, 4 mm or more, 5 mm or more, 6 mm or more, 7 mm or more, 8 mm or more, or 9 mm or more, and 10 mm or less, 9 mm or less, 8 mm or less, 7 mm or less, 6 mm or less, 5 mm or less, 4 mm or less, or 3 mm or less.

According to such numerical ranges, it is possible to configure the dental abutment construction member of the present invention which is applicable to a large number of teeth.

### Second Embodiment

A second embodiment of the present invention will be described below. An example of the second embodiment is shown as a first aspect of the second embodiment. The present embodiment will be described by using FIG. 5. A dental abutment construction member 150 according to the first aspect of the second embodiment is the dental abutment construction member of the first aspect of the first embodiment, and is configured such that an upper surface 151 and a lower surface 155 form annular shapes 251 and 255 respectively, and in between the upper surface 151 and the lower surface 155, there is an intermediate surface 271 which separates the upper surface 151 and the lower surface 155, and an outer peripheral surface 157 connects an outer edge 152 of the annular shape 251 of the upper surface 151 and an outer edge 156 of the annular shape 255 of the lower surface 155, and an inner peripheral surface 159 connects an inner edge 154 of the annular shape 251 of the upper surface 151 and an edge which the inner peripheral surface 159 and an upper-side surface 272 of the intermediate surface 271 connect, and also connects an inner edge 158 of the annular shape 255 of the lower surface 155 and an edge which the inner peripheral surface 159 and a lower-side surface 273 of the intermediate surface 271 connect.

By making such configuration, the intermediate surface acts to reinforce the dental abutment construction member according to the present invention, and even in a case in which a size in a short direction of the member is large, it is possible to improve strength as that member, thereby enabling to exert easily the advantageous effect described in the first embodiment.

Furthermore, the second embodiment can also be configured as a second aspect of the second embodiment as described below. The present embodiment will be described by using FIG. 5. In other words, a dental abutment construction member according to the second aspect of the second embodiment, as shown in FIG. 5, is the dental abutment construction member according to the first aspect of the second embodiment, and is configured such that the inner edge 154 of the annular shape 251 of the upper surface 151 is an elliptical shape 254, and the inner edge 158 of the annular shape 255 of the lower surface 155 is an elliptical shape 258.

By making such configuration, there is an advantage of making it easy to match with the abovementioned elliptical tooth which is longer in the longer direction.

Furthermore, the second embodiment can also be configured as a third aspect of the second embodiment as described below. The present embodiment will be described by using FIG. 5. In other words, a dental abutment construction member according to the third aspect of the second embodiment, as shown in FIG. 5, is the dental abutment construction member of the second aspect of the second embodiment, and is configured such that an axis 108 in a longer direction of the elliptical shape 254 which is the inner edge 154 of the annular shape 251 of the upper surface 151 and an axis 109 in a longer direction of the elliptical shape 258 which is the inner edge 158 of the annular shape 255 of the lower surface 155 are in the same plane.

By making the configuration such that the axis 108 in the longer direction of the elliptical shape 254 and the axis 109 in the longer direction of the elliptical shape 258 are in the same plane, at the time of preparing the dental abutment construction member according to the present invention by using a mold, demolding becomes easy, thereby the preparation of the member becoming easy.

Furthermore, the dental abutment construction member according to the second embodiment can also be configured as a fourth aspect of the second embodiment as described below. The present embodiment will be described by using FIG. 5. In other words, the fourth aspect of the second embodiment, in FIG. 5, is the dental abutment construction member according to any one the aspects from the first aspect of the second embodiment to the third aspect of the second embodiment, and is configured such that both the outer peripheral surface 157 and the inner peripheral surface 159 are flat surfaces.

By making the outer peripheral surface 157 and the inner peripheral surface 159 flat surfaces in such manner, the dental abutment construction member according to the present invention can be prepared easily.

Furthermore, the dental abutment construction member according to the second embodiment can also be configured as a fifth aspect of the second embodiment as described below. The present embodiment will be described by using FIG. 3 and FIG. 5. In other words, the fifth aspect of the second embodiment, the dental abutment construction shown in FIG. 5, is the dental abutment construction member according to any one of the aspects from the first aspect of the second embodiment to the third aspect of the second embodiment, and is configured such that the outer peripheral surface 157 in FIG. 5 is an uneven surface, and the inner peripheral surface 159 is a flat surface, and the uneven surface has a recess portion 136 and a protruding portion 138 on the outer peripheral surface 137 as shown in FIG. 3.

By providing such unevenness on the outer peripheral surface, the dental abutment construction member is attached more firmly to the composite resin in which it is embedded at the time of abutment construction, and it is possible to make it a strong abutment.

Furthermore, the dental abutment construction member according to the second embodiment can also be configured as a sixth aspect of the second embodiment as described below. The present embodiment will be described by using FIG. 4 and FIG. 5. In other words, the sixth aspect of the second embodiment, in the dental abutment construction member shown in FIG. 5, is the dental abutment construction member of the fifth aspect of the second embodiment, and is configured such that the uneven shape of the uneven surface of the outer peripheral surface 157 is a screw-thread shape. The screw-thread shape on an outer peripheral surface is as shown in the screw thread shape 148.

By making a configuration such that the uneven shape of the outer peripheral surface is the screw-thread shape 148, the dental abutment construction member is attached more firmly to the composite resin in which it is embedded at the time of abutment construction, and it is possible to make it a strong abutment.

Furthermore, the dental abutment construction member according to the second embodiment can also be configured as a seventh aspect of the second embodiment as described below. The present embodiment will be described by using FIG. 5. In other words, the seventh aspect of the second embodiment, in FIG. 5, is the dental abutment construction member according to any one of the aspects from the second aspect of the second embodiment to the sixth aspect of the second embodiment, and is configured such that a length in the longer direction of the elliptical shape 254 which is the inner edge 154 of the annular shape 251 of the upper surface 151 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a length in a short direction of the elliptical shape 254 which is the inner edge 154 of the annular shape 251 of the upper surface 151 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a length in the longer direction of the elliptical shape 258 which is the inner edge 158 of the annular shape 255 of the lower surface 155 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a length in a short direction of the elliptical shape 158 which is the inner edge of the annular portion 255 of the lower surface 155 is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a thickness in a vertical direction of the intermediate surface is in a range including both ends of a range from 0.5 mm to 4.5 mm, for example, 0.5 mm or more, 0.6 mm or more, 0.7 mm or more, 0.8 mm or more, 0.9 mm or more, 1 mm or more, 1.5 mm or more, 2 mm or more, 2.5 mm or more, 3 mm or more, 3.5 mm or more, or 4 mm or more, and 4.5 mm or less, 3.5 mm or less, 3 mm or less, 2.5 mm or less, 2 mm or less, 1.5 mm or less, 1 mm or less, 0.9 mm or less, 0.8 mm or less, 0.7 mm or less, or 0.6 mm or less, and the upper-side surface 272 of the intermediate surface 271 is positioned at a position in a range including both ends of a range from 1.5 mm to 5 mm, for example 1.5 mm or more, 2 mm or more, 3 mm or more, or 4 mm or more, and 5 mm or less, 4 mm or less, 3 mm or less, or 2 mm or less, from the lower surface 155, and a width on a horizontal plane of the outer peripheral surface 157 is in a range including both ends of a range from 1.5 mm to 10 mm, for example, 1.5 mm or more, 2 mm or more, 3 mm or more, 4 mm or more, 5 mm or more, 6 mm or more, 7 mm or more, 8 mm or more, or 9 mm or more, and 10 mm or less, 9 mm or less, 8 mm or less, 7 mm or less, 6 mm or less, 5 mm or less, 4 mm or less, 3 mm or less, or 2 mm or less, and a thickness of a wall formed by the outer peripheral surface 157 and the inner peripheral surface 159 is at least 0.5 mm, for example, 0.5 mm or more, 0.6 mm or more, 0.7 mm or more, 0.8 mm or more, 0.9 mm or more, 1 mm or more, 1.5 mm or more, 2 mm or more, or 2.5 mm or more, and 3 mm or less, 2.5 mm or less, 2 mm or less, 1.5 mm or less, 1 mm or less, 0.9 mm or less, 0.8 mm or less, 0.7 mm or less, 0.6 mm or less, and a height of the dental abutment construction member 150 is in a range including both ends of a range from 2 mm to 10 mm, for example, 2 mm or more, 3 mm or more, 4 mm or more, 5 mm or more, 6 mm or more, 7 mm or more, 8 mm or more, or 9 mm or more, and 10 mm or less, 9 mm or less, 8 mm or less, 7 mm or less, 6 mm or less, 5 mm or less, 4 mm or less, or 3 mm or less.

According to such numerical ranges, it is possible to configure the dental abutment construction member of the present invention which is applicable to a large number of teeth.

### Third Embodiment

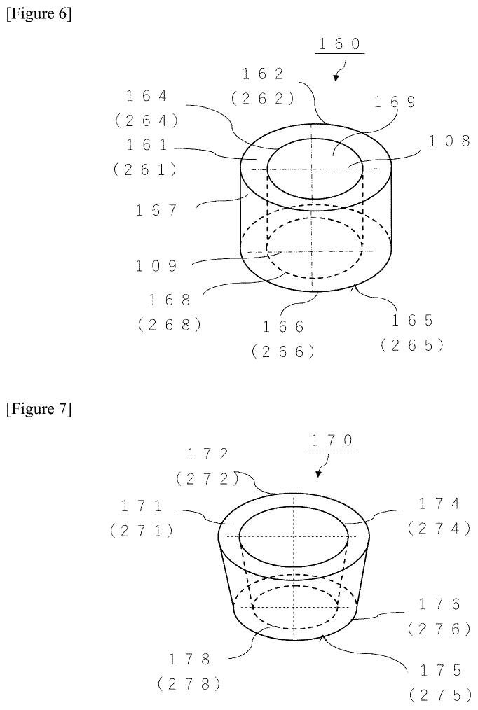

A third embodiment of the present invention will be described below. An example of the third embodiment is shown as a first aspect of the third embodiment. The present embodiment will be described by using FIG. 6.

A dental abutment construction member according to the first aspect of the third embodiment, as shown in FIG. 6, is a dental abutment construction member 160 described in any one of the aspects from the third aspect of the first embodiment to the fifth aspect of the first embodiment or the second aspect of the second embodiment to the fourth aspect of the second embodiment, and is configured such that an outer edge 162 of an annular shape 261 of an upper surface 161 is an elliptical shape 262, and an outer edge 166 of an annular shape 265 of a lower surface 165 is an elliptical shape 266, and the dental abutment construction member has an outer diameter at which, each of a length in a longer direction of the elliptical shape 262 formed by the outer edge 162 of the annular shape 261 of the upper surface 161, a length in a short direction of the elliptical shape 262 which is the outer edge 162 of the annular shape 261 of the upper surface 161, a length in a longer direction of the elliptical shape 266 which is the outer edge 166 of the annular shape 265 of the lower surface 165, and a length in a short direction of the elliptical shape 266 which is the outer edge 166 of the annular shape 265 of the lower surface 165 is the same length, and the dental abutment construction member has an inner diameter at which, each of a length in a longer direction of an elliptical shape 264 formed by an inner edge 164 of the annular shape 261 of the upper surface 161, a length in a short direction of the elliptical shape 264 which is the inner edge 164 of the annular shape 261 of the upper surface 161, a length in a longer direction of an elliptical shape 268 which is an inner edge 168 of the annular shape 265 of the lower surface 165, and a length in a short direction of the elliptical shape 268 which is the inner edge 168 of the annular shape 265 of the lower surface 165 is the same length, or in other words, each of the shape of the outer edge and the inner edge of the upper surface and the lower surface is a perfect circular shape.

In this description as FIG. 6, it is a description suitable for the aspects from the third aspect of the first embodiment to the fifth aspect of the first embodiment which is a configuration in which the intermediate surface in the aspects from the second aspect of the second embodiment to the fourth aspect of the second embodiment is not there, and even in a case in which there is an intermediate surface, the description is similar to the abovementioned description

By making such configuration, at the time of preparing the dental abutment construction member according to the present invention by using a mold, demolding becomes easy, thereby enabling to make the dental abutment construction according to the present invention commonly applicable to a large number of teeth.

Furthermore, the dental abutment construction member according to the third embodiment can also be configured as a second aspect of the third embodiment as described below. In other words, in FIG. 6, the second aspect of the third embodiment is the dental abutment construction member of the first aspect of the third embodiment, and is configured such that the outer diameter is in a range including both ends of a range from 1.5 mm to 10 mm, for example, 1.5 mm or more, 2 mm or more, 3 mm or more, 4 mm or more, 5 mm or more, 6 mm or more, 7 mm or more, 8 mm or more, or 9 mm or more, and 10 mm or less, 9 mm or less, 8 mm or less, 7 mm or less, 6 mm or less, 5 mm or less, 4 mm or less, 3 mm or less, or 2 mm or less, and the inner diameter is in a range including both ends of a range from 0.5 mm to 9 mm, for example, 0.5 mm or more, 1 mm or more, 2 mm or more, 3 mm or more, 4 mm or more, 5 mm or more, 6 mm or more, 7 mm or more, or 8 mm or more, and 9 mm or less, 8 mm or less, 7 mm or less, 6 mm or less, 5 mm or less, 4 mm or less, 3 mm or less, 2 mm or less, or 1 mm or less, and a thickness of a wall formed by an outer peripheral surface 167 and an inner peripheral surface 169 is at least 0.5 mm, for example, 0.5 mm or more, 0.6 mm or more, 0.7 mm or more, 0.8 mm or more, 0.9 mm or more, 1 mm or more, 1.5 mm or more, 2 mm or more, or 2.5 mm or more, and 3 mm or less, 2.5 mm or less, 2 mm or less, 1.5 mm or less, 1 mm or less, 0.9 mm or less, 0.8 mm or less, 0.7 mm or less, or 0.6 mm or less, and a height of the dental abutment construction member 160 is in a range including both ends of a range from 2 mm to 10 mm, for example, 2 mm or more, 3 mm or more, 4 mm or more, 5 mm or more, 6 mm or more, 7 mm or more, 8 mm or more, or 9 mm or more, and 10 mm or less, 9 mm or less, 8 mm or less, 7 mm or less, 6 mm or less, 5 mm or less, 4 mm or less, or 3 mm or less.

In this description as FIG. 6, it is a description suitable for the aspects from the third aspect of the first embodiment to the fifth aspect of the first embodiment which is a configuration in which the intermediate surface in the aspects from the second aspect of the second embodiment to the fourth aspect of the second embodiment is not there, and even in a case in which there is an intermediate surface, the description is similar to the abovementioned description. Regarding a thickness and a position of the intermediate surface, it can have a configuration similar to that described as the seventh aspect of the second embodiment.

According to such numerical ranges, it is possible to configure the dental abutment construction member of the present invention which is applicable to a large number of teeth.

### Fourth Embodiment

A fourth embodiment of the present invention will be described below. An example of the fourth embodiment is shown as a first aspect of the fourth embodiment. The present embodiment will be described by using FIG. 7. A dental abutment construction member 170 according to the first aspect of the fourth embodiment is the dental abutment construction member described in any one of the aspects from the third aspect of the first embodiment to the eighth aspect of the first embodiment and from the second aspect of the second embodiment to the seventh aspect of the second embodiment, and is configured such that a length in a longer direction of an elliptical shape 274 forming an inner edge 174 of an annular shape 271 of an upper surface 171 is longer than a length in a longer direction of an elliptical shape 278 forming an inner edge 178 of an annular shape 275 of a lower surface 175, and a length in a short direction of the elliptical shape 274 forming the inner edge 174 of the annular shape 271 of the upper surface 171 is longer than a length in a short direction of the elliptical shape 278 forming the inner edge 178 of the annular shape 275 of the lower surface 175.

Here, usage of the intermediate surface in the aspects from the second aspect of the second embodiment to the fourth aspect of the second embodiment is similar to the usage described in the second aspect of the third embodiment.

The dental abutment construction member configurated in such manner can be used by disposing vertically in the abutment construction as described above, and can also be used by turning upside down. The dental abutment construction member according to the present embodiment can easily exert the advantageous effects described in the first embodiment in accordance with a shape of a tooth such as a molar and a front tooth, for which it is used.

### Fifth Embodiment

A fifth embodiment of the present invention will be described below. An example of the fifth embodiment will be shown as a first aspect of the fifth embodiment. The present embodiment will be described below by using FIG. 7. A dental abutment construction member according to the first aspect of the fifth embodiment is the dental abutment construction member described in any one of the aspects from the third aspect of the first embodiment to the eighth aspect of the first embodiment or from the second aspect of the second embodiment to the seventh aspect of the second embodiment, and is configured such that the dental abutment construction member has a diameter of an upper-surface inner edge at which, the length in the longer direction of the elliptical shape 274 which is the inner edge 174 of the annular shape 271 of the upper surface 171 and the length in the short direction of the elliptical shape 274 which is the inner edge 174 of the annular shape 271 of the upper surface 171 are same, and the dental abutment construction member has a diameter of a lower-surface inner edge at which, the length in the longer direction of the elliptical shape 278 which is the inner edge 178 of the annular shape 275 of the lower surface 175 and the length in the short direction of the elliptical shape 278 which is the inner edge 178 of the annular shape 275 of the lower surface 175 are same, and the diameter of the upper-surface inner edge is larger than the diameter of the lower-surface inner edge.

Here, usage of the intermediate surface in the aspects from the second aspect of the second embodiment to the fourth aspect of the second embodiment is similar to the usage described in the second aspect of the third embodiment.

The dental abutment construction member configured in such manner can be used by disposing vertically in the abutment construction as described above, and can also be used by turning upside down. The dental abutment construction member according to the present embodiment can easily exert the advantageous effects described in the first embodiment in accordance with a shape of a tooth such as a molar and a front tooth, for which it is used.

### Sixth Embodiment

A sixth embodiment of the present invention will be described below. An example of the sixth embodiment will be shown as a first aspect of the sixth embodiment. A dental abutment construction member according to the first aspect of the sixth embodiment is the dental abutment construction member described in any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, or the first aspect of the fifth embodiment, and is configured such that at least a part of a surface of the dental abutment construction member has a rough surface. Here, the rough surface refers to a surface having a surface roughness of a degree that can be obtained by carrying out sand blasting.

By configuring in such manner, the dental abutment construction member according to the present invention is stuck more firmly to the composite resin in which it is embedded in the abutment construction, and it is possible to exert better the effects mentioned in the first embodiment, such as enabling to reinforce the cervical portion which is a part on which the stress of the composite resin abutment construction is concentrated, by the dental abutment construction member according to the present invention, and to construct a strong abutment by integrating a construction body and the tooth root.

### Seventh Embodiment

A seventh embodiment of the present invention will be described below. An example of the seventh embodiment will be shown as a first aspect of the seventh embodiment. A dental abutment construction member according to the first aspect of the seventh embodiment is the dental abutment construction member described in any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, or the first aspect of the sixth embodiment, and is configured to be formed of a material which includes ceramic.

By forming the dental abutment construction member according to the present invention of a material which includes a material cited as the present embodiment, it is possible to exert better the effects mentioned in the first embodiment, such as enabling to reinforce the cervical portion which is a part on which the stress of the composite resin abutment construction is concentrated, by the dental abutment construction member according to the present invention, and to construct a strong abutment by integrating a construction body and the tooth root. Moreover, an issue of metal allergy as in a case when a metal post was used does not arise.

Furthermore, the dental abutment construction member according to the seventh embodiment can also be configured as a second aspect of the seventh embodiment as described below. In other words, a dental abutment construction member according to the second aspect of the seventh embodiment is the dental abutment construction member according to the first aspect of the seventh embodiment, and is configured such that the material which includes ceramic is selected from alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate, and zirconia-toughened lithium disilicate.

By forming the dental abutment construction member according to the present invention of a material which includes a material cited as the present embodiment, it is possible to exert better the effects mentioned in the first embodiment, such as enabling to reinforce the cervical portion which is a part on which the stress of the composite resin abutment construction is concentrated, by the dental abutment construction member according to the present invention, and to construct a strong abutment by integrating a construction body and the tooth root. Moreover, an issue of metal allergy as in a case when a metal post was used does not arise.

### Eighth Embodiment

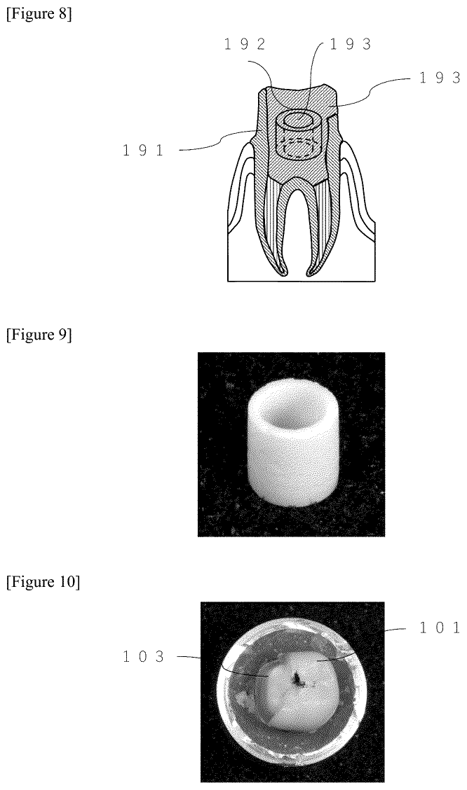

An eighth embodiment of the present invention will be described below. An example of the eighth embodiment will be shown as a first aspect of the eighth embodiment. The present embodiment will be described by using FIG. 8. A dental abutment construction member according to the first aspect of the eighth embodiment is the dental abutment construction member described in any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, the first aspect of the sixth embodiment, and the first aspect of the seventh embodiment or the second aspect of the seventh embodiment, and is configured to be used by being embedded in a composite resin in an abutment construction of a target tooth for which the dental abutment construction member is used.

FIG. 8 is a cross-sectional view showing an inside of an abutment construction cavity treated by using the dental abutment construction member according to the present invention. In FIG. 8, a dental abutment construction member 192 is embedded in a composite resin 193. In this cross-sectional view, the dental abutment construction member 192 is shown by a perspective view. For the dental abutment construction member 192 in FIG. 8, an example in which, the dental abutment construction member is a circular tube of which, each of a shape of the outer edge and a shape of the inner edge of the upper surface and the lower surface of the dental abutment construction member in the first aspect of the third embodiment shown in FIG. 6 is a perfect circular shape, is used. The dental abutment construction member 192 is embedded in the composite resin 193 such that even an interior portion of the circular tube which is the dental abutment construction member 192 is filled up with the composite resin 193.

The dental abutment construction member according to the present invention, by being used upon being embedded in the composite resin in the abutment construction as mentioned in the section of the first embodiment, exerts advantageous effects thereof. By configuring as in the present embodiment, the dental abutment construction member according to the present invention favorably exerts the effects mentioned in the section of the first embodiment.

### Ninth Embodiment

A ninth embodiment of the present invention will be described below. An example of the ninth embodiment will be shown as a first aspect of the ninth embodiment. The present embodiment will be described by using FIG. 8. A dental abutment construction member according to the first aspect of the ninth embodiment is the dental abutment construction member described in any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, the first aspect of the sixth embodiment, the first aspect of the seventh embodiment, or the first aspect of the eighth embodiment, and is configured to be used by being disposed such that a vertical direction of the dental abutment construction member is directed from a root toward a crown of a target tooth for which the dental abutment construction member is used.

The present embodiment is shown in FIG. 8. As shown in FIG. 8, the dental abutment construction member 192 is used by being disposed such that a vertical direction of the dental abutment construction member 192 is directed from a root of a target tooth toward a crown of the target tooth for which the dental abutment construction member 192 is used.

The dental abutment construction member according to the present invention, functions favorably in a state of the tubular shape thereof being erect inside a tooth being treated, to reinforce the cervical portion of the tooth on which a substantial stress of the composite resin abutment concentration is concentrated. Consequently, by configuring as in the present embodiment, the dental abutment construction member according to the present invention can be made to function favorably, and it is possible exert favorably the advantageous effects mentioned in the first embodiment.

### Tenth Embodiment

A tenth embodiment of the present invention will be described. An example of the tenth embodiment will be shown as a first aspect of the tenth embodiment.

The present embodiment will be described by using FIG. 8. A dental abutment construction member according to the first aspect of the tenth embodiment is the dental abutment construction member described in any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, the first aspect of the sixth embodiment, the first aspect of the seventh embodiment, the first aspect of the eighth embodiment, or the first aspect of the ninth embodiment, and is configured to be embedded in a composite resin such that the dental abutment construction member is not in contact with a tooth substance inside an abutment construction cavity of the target tooth for which the dental abutment construction member is used.

The present embodiment is shown in FIG. 8. As in FIG. 8, the dental abutment construction member 192 is embedded in the composite resin 193 such that there is no contact with a tooth substance 191 inside the abutment construction cavity of the target tooth for which the dental abutment construction member 192 is used.

If the dental abutment construction member is in contact with the tooth substance inside the abutment construction cavity, when a force is applied due to an occlusion of the tooth treated with the other tooth, concentrated force acts on the tooth substance at a location at which the dental abutment construction member is in contact with the tooth substance, at the interior of the tooth treated, and there is a possibility of causing fracture of the tooth substance. By making a configuration such that the dental abutment construction member 192, as shown in FIG. 8, is not in contact with the tooth substance 191 inside the abutment construction cavity of the target tooth for which the dental abutment construction member is used, it is possible to reduce a risk of fracturing of the tooth substance. It is essential that there is a layer of the composite resin 193 used for filling between the dental abutment construction member 192 and the tooth substance 191.

### Eleventh Embodiment

An eleventh embodiment of the present invention will be described below. An example of the eleventh embodiment will be described as a first aspect of the eleventh embodiment. A method of preparing dental abutment construction member according to the first aspect of the eleventh embodiment by using a material for preparing which includes at least a material selected from ceramic, alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate, and zirconia-toughened lithium disilicate, is configured to include, forming a member which matches with a shape of the dental abutment construction member according to any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, or the first aspect of the sixth embodiment.

By using this method of preparing dental abutment construction member, it is possible to prepare the dental abutment construction member according to the present invention.

Specifically, it is possible to prepare by the following process for example.

In other words, in the method of preparing dental abutment construction member which includes carrying out heat treatment on a molded component to begin with, by carrying out the heat treatment on the molded component, dimensions of the molded component contract in accordance with a material of the molded component, and a proportion of contraction with respect to dimensions of a base material is let to be a contraction ratio corresponding to the base material.

The present method of preparing may include, for example, preparing a molded component having a shape larger by only a reciprocal multiple of the contraction ratio for the material, than a shape of the dental abutment construction member of any one of the abovementioned aspects, and further carrying out the heat treatment on the molded component. In such manner, it is possible to prepare the dental abutment construction member according to the present invention.

### Twelfth Embodiment

A twelfth embodiment of the present invention will be described below. An example of the twelfth embodiment will be described as a first aspect of the twelfth embodiment. A method of preparing dental abutment construction member according to the first aspect of the twelfth embodiment by cutting a base material in which a material for preparing which includes at least a material selected from ceramic, alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate, and zirconia-toughened lithium disilicate is used, is configured to include, preparing the base material, and preparing a member which matches with a shape of the dental abutment construction member according to any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, or the first aspect of the sixth embodiment by machining the base material.

By this method of preparing, it is possible to prepare the dental abutment construction member according to the present invention.

Specifically, it is possible to prepare by a process which includes heat treatment described below for example.

In the method of preparing dental abutment construction member which includes carrying out heat treatment on a member formed by cutting a base material, by carrying out heat treatment on the member formed by cutting the base material, the member formed contracts in accordance with the dimensions of a component prepared by using the base material, and the proportion of contraction depending on the base material with respect to the dimensions of the base material caused by carrying out the heat treatment is let to be the contraction ratio corresponding to the base material.

The present method of preparing dental abutment construction member which includes, for example, preparing a base material adequately larger than the size of the dental abutment construction member prepared by using a material including at least the abovementioned selected material, preparing a cut object having a shape larger by only a reciprocal multiple of the contraction ratio corresponding to the base material of the shape of the dental abutment construction member according to any one of the abovementioned aspects by machining, may include as well the heat treatment to be further carried out on the cut object.

### Thirteenth Embodiment

A thirteenth embodiment of the present invention will be described below. An example of the thirteenth embodiment will be described as a first aspect of the thirteenth embodiment. A method of preparing dental abutment construction member according to the first aspect of the thirteenth embodiment is configured to include, arranging a casting mold which matches with a shape of the dental abutment construction member according to any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, or the first aspect of the sixth embodiment, pouring a material which includes at least a glass ceramics material into the casting mold, and pressurizing the material poured.

By this method of preparing, it is possible to prepare the dental abutment construction member according to the present embodiment.

### Fourteenth Embodiment

A fourteenth embodiment of the present invention will be described below. An example of the fourteenth embodiment will be described as a first aspect of the fourteenth embodiment. A method of preparing dental abutment construction member according to the first aspect of the fourteenth embodiment by a 3D (3-dimensional) printing apparatus by using a material for preparing which includes at least a material selected from ceramic, alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate, and zirconia-toughened lithium disilicate is configured to include, creating shape data for the 3D printing apparatus to prepare a member having a shape of the dental abutment construction member according to any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, or the first aspect of the sixth embodiment, inputting the shape data to the 3D printing apparatus, and preparing a member which matches with the shape of the dental abutment construction member by putting the 3D printing apparatus into operation, by using a material for which the heat treatment is not necessary.

By this method of preparing, it is possible to prepare the dental abutment construction member according to the present embodiment. There is a merit that it can be prepared easily, especially in a case in which the shape of the dental abutment construction member changes in a vertical direction in a complex manner.

Specifically, the dental abutment construction member can be prepared as described below depending on whether or not a process including heat treatment is necessary, for example.

In a case in which the method of preparing dental abutment construction member does not require the heat treatment according to the material of preparing, a method of preparing which includes selecting a material which does not require heat treatment as a material for the dental abutment construction member from the abovementioned materials for preparing, creating shape data for the 3D printing apparatus to prepare a member having a shape of the dental abutment construction member according to any one of the abovementioned aspects, inputting the shape data to the 3D printing apparatus, and preparing a member having a shape of the dental abutment construction member by putting the 3D printing apparatus into operation by using a material which does not require the heat treatment, may be used.

In a case in which, the method of preparing dental abutment construction member requires the heat treatment depending on the material for preparing, by selecting from the materials for preparing, a material which requires the heat treatment, which is to be used as a material for the dental abutment construction member, the molded component molded by using the material which requires the heat treatment contracts upon being subjected to heat treatment, and the proportion of contraction of the molded component by being subjected to heat treatment is let to be a contraction ratio corresponding to the material which requires heat treatment.

A shape larger by only a reciprocal multiple of the contraction ratio for the material which requires the heat treatment, than the shape of the dental abutment construction member according to any one of the abovementioned aspects is called as an intermediate shape, and a method of preparing dental abutment construction member which includes creating intermediate-shape data for a 3D printing apparatus to prepare a member which has the intermediate shape, inputting the intermediate-shape data to the 3D printing apparatus, preparing an intermediate member which has the intermediate shape by putting the 3D printing apparatus into operation using the material which requires the heat treatment, and carrying out the heat treatment on the intermediate member that has been prepared by putting the 3D printing apparatus into operation, may be used.

For the treatment using the dental abutment construction member according to the present invention, a dental treatment method can be configured to include disposing the dental abutment construction member according to any one of the aspects from the first aspect of the first embodiment to the eighth aspect of the first embodiment, from the first aspect of the second embodiment to the seventh aspect of the second embodiment, from the first aspect of the third embodiment to the second aspect of the third embodiment, the first aspect of the fourth embodiment, the first aspect of the fifth embodiment, or the first aspect of the sixth embodiment in an abutment construction cavity of a target tooth, constructing an abutment by embedding the dental abutment construction member in a composite resin, and putting a crown on the target tooth for which the abutment has been constructed.

### Evaluation of Examples

A prototype of the dental abutment construction member according to the present invention was prepared, and characteristics thereof were evaluated. The prototype will be described below. The appearance of the prototype of the dental abutment construction member prepared is shown in FIG. 9. An outer shape of the prototype is a tubular shape with an outer diameter of the tube 5.0 mm, a thickness of a wall formed by an outer wall and an inner wall of the tube 0.7 mm, and a height 5.0 mm. Moreover, 3 mol % yttria-partially stabilized zirconia was used for the material of the prototype. A method of preparing is a method of sintering a molded component having a large shape corresponding to a proportion of contraction of the material used due to sintering. For a shape of the prototype to be prepared, a mold having a large shape anticipating the proportion of contraction or in other words, contraction ratio, at the time of sintering the zirconia used, was arranged. For the prototype, a mold having a circular cylindrical shape which is a structure with no hole therein was used. A powder of zirconia was put in this mold, then was pressurized under a pressure of 20 MPa for one minute, and a structure of cylindrical shaped zirconia was prepared. Thereafter, an inside of the cylindrical-shaped structure was hollowed out, and a molded component shaped to be circular cylindrical was prepared. The prototype was made by sintering this molded component.

An experimental tooth for abutment construction having an abutment construction cavity formed in advance in an experimental molar by a composite resin for abutment construction was arranged. The dental abutment construction member prepared was embedded in this experimental tooth for abutment construction by using the composite resin. FIG. 8 is a diagram in which the embedded state is shown. In FIG. 8, a tooth is shown in a cross-section, and the embedded dental abutment construction member is shown in a perspective view. Moreover, a hatched portion showing a gum in cross section is omitted. In FIG. 10, the prototype shown in FIG. 9, of which a part of a tooth crown of a molar 101 has been removed and a composite resin 103 having an interior thereof has been solidified is exposed, is shown. A dental abutment construction member shown in FIG. 9 which was prepared on experimental basis is embedded inside the solidified composite resin 103. A crown of the prototype shown in FIG. 10 is prepared by using lithium disilicate glass ceramic.

In FIG. 10, the dental abutment construction member is disposed such that a vertical direction thereof is directed from a tooth root toward a tooth crown of the experimental tooth for the abutment construction, and is embedded in the composite resin. By disposing in such manner, when a force directed from the tooth crown toward the tooth root is applied to the tooth treated by embedding the present dental abutment construction member due to an occlusal with other tooth, the dental abutment construction member withstands the force at the interior of the tooth and is capable of distributing that force to a lower surface or the tubular-shaped wall surface of the dental abutment construction member.

The present dental abutment construction member, by the tubular structure thereof, reinforces the cervical portion which is a part subjected to stress concentration by a composite resin abutment construction. Consequently, it is possible to reinforce by the dental abutment construction member according to the present invention, and to construct a strong abutment by integrating the construction body and the tooth root. Therefore, as compared to the conventional abutment construction using a post, there is no stress concentrated on the cervical portion, thereby making it possible to reinforce the cervical portion which is a part subjected to stress concentration, and to construct a strong abutment by integrating the construction body and the tooth root.

Moreover, by using the present dental abutment construction member, as there is no need to make a post hole in the abutment construction, it is possible to reduce a risk of causing a perforation or a risk of a root fracture, and to prevent weakening of the remaining tooth substance. Furthermore, there being no need to make the post hole, it is possible to facilitate shortening of treatment time.

Moreover, the present dental abutment construction member is embedded in the composite resin so that there is no contact with a tooth substance inside the abutment construction cavity. If the dental abutment construction member is in contact with the tooth substance inside the abutment construction cavity, when a force is applied due to an occlusion of the tooth treated with the other tooth, concentrated force acts on the tooth substance at a location at which the dental abutment construction member is in contact with the tooth substance, at the interior of the tooth treated, and there is a possibility of causing fracture of the tooth substance. It is essential that there is a layer of a composite resin used for filling between the dental abutment construction member and the tooth substance. This is because the layer of a composite resin functions as a buffer layer.

A surface strain on a crown and a tooth root developed on a tooth responding to the force applied, for a tooth for which the abutment construction was carried out by using the dental abutment construction member prepared for a molar for test, was measured. The crown used for this measurement was prepared by using 4 mol % yttria-partially stabilized zirconia. In this measurement, a strain gauge was attached at each of a crown buccal side, a crown lingual side, a tooth root buccal side, and a tooth root lingual side of this tooth to be tested, and a load of 200 N was applied by using an indenter having a hemispherical tip of 2 mm diameter from an upper portion of the tooth. Moreover, for comparison, a similar measurement was carried out for a tooth which was treated by carrying out abutment construction by a similar method by using a resin core constructed only by a composite resin in which no post was used and a fiber core in which a fiber post was used in combination.

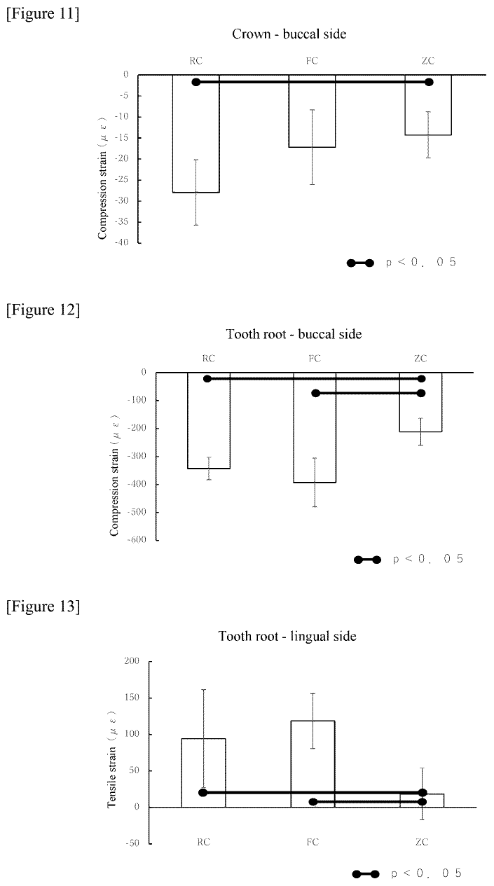

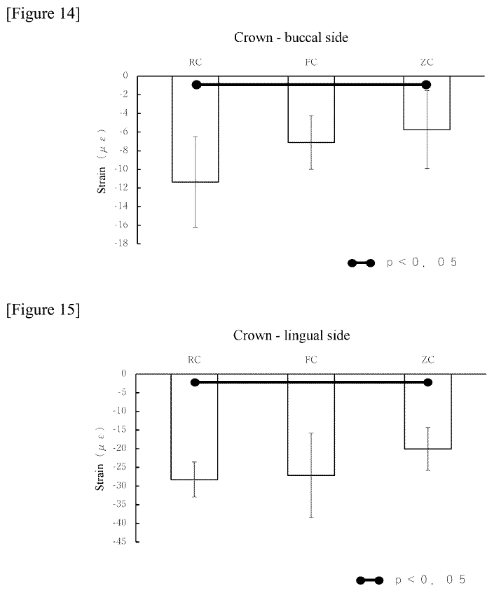

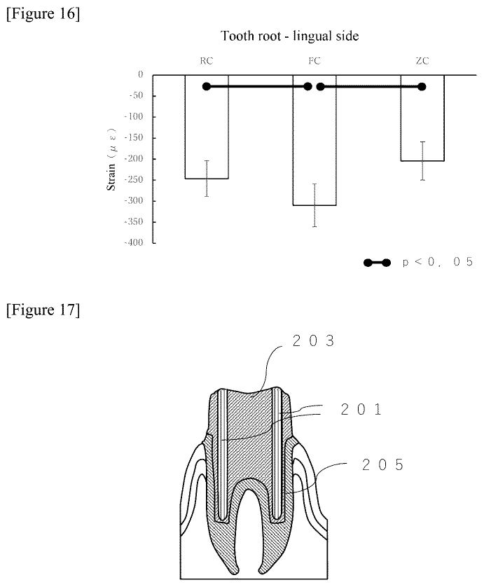

Measurement results thereof are shown in FIG. 11 to FIG. 16. A set of diagrams from FIG. 11 to FIG. 13 and a set of diagrams from FIG. 14 to FIG. 16 are graphical representation of results of measurement of a surface strain on a crown buccal side, a crown lingual side, a tooth root buccal side, and a tooth root lingual side when a load was applied from an upper portion to a crown occlusal surface of each tooth tested. The dental abutment construction member according to the present invention is indicated by symbol ‘ZC’. The composite resin core in an example of data for comparison is indicated by symbol ‘RC’ and the composite resin core in which the fiber post was used in combination is indicated by symbol ‘FC’. The set of diagrams from FIG. 11 to FIG. 13 show data when a load was applied to a crown occlusal surface buccal cusp inner incline, and the set of diagrams from FIG. 14 to FIG. 16 show data when a load was applied to a crown occlusal surface central fossa of the tooth tested. In each of the graphs, an average value of result of measurement carried out eight times is shown by a bar chart, and a standard deviation is indicated in the form of an error bar at a tip of the bar chart. The tooth treated by using the dental abutment construction member according to the present invention has a small strain at a number of measurement locations as compared to that for a tooth for which the composite resin core was used and a tooth for which the composite resin core in which the fiber post was used in combination, and this shows an effectiveness of carrying out the abutment construction by using the dental abutment construction member according to the present invention.

### INDUSTRIAL APPLICABILITY

The dental abutment construction member according to the present invention can be used as a reinforcing material in a useful and inexpensive abutment construction.

Description of Reference Numerals

| | |
|---|---|
| 108 | axis |
| 109 | axis |
| 110, 121, 150, 160, 170 | dental abutment construction |
| | member |
| 111, 123, 151, 161, 171 | upper surface |
| 112, 116, 152, 156, 162, 166, 172 | outer edge |
| 114, 118, 154, 158, 164, 168, 174 | inner edge |
| 115, 125, 155, 165, 175 | lower surface |
| 117, 127, 137, 157, 167 | outer peripheral surface |
| 119, 159, 169 | inner peripheral surface |
| 136 | recess portion |
| 138 | protruding portion |
| 148 | screw-thread shape |
| 211, 215, 251, 255, 261, 265, 271, 275 | annular shape |
| 214, 218, 254, 258, 264, 268, 274, 278 | elliptical shape |
| 271 | intermediate surface |

1. A dental abutment construction member having a tubular shape, comprising:
an upper surface;
a lower surface;
an outer peripheral surface; and
an inner peripheral surface,
wherein each of the upper surface and the lower surface has an annular shape,
wherein the outer peripheral surface connects an outer edge of the annular shape of the upper surface and an outer edge of the annular shape of the lower surface,
wherein the inner peripheral surface connects an inner edge of the annular shape of the upper surface and an inner edge of the annular shape of the lower surface,
wherein the inner edge of the annular shape of the upper surface has an elliptical shape,
wherein the inner edge of the annular shape of the lower surface has an elliptical shape,
wherein an axis in a longer direction of the elliptical shape which is the inner edge of the annular shape of the upper surface and an axis in a longer direction of the elliptical shape which is the inner edge of the annular shape of the lower surface are in the same plane,
wherein a length in the longer direction of the elliptical shape which is the inner edge of the annular shape of the upper surface is in a range including both ends of a range from 4.0 mm to 9 mm, and a length in a short direction of the elliptical shape which is the inner edge of the annular shape of the upper surface is in a range including both ends of a range from 4.0 mm to 9 mm,
wherein a length in the longer direction of the elliptical shape which is the inner edge of the annular shape of the lower surface is in a range including both ends of a range from 4.0 mm to 9 mm, and a length in the short direction of the elliptical shape which is the inner edge of the annular shape of the lower surface is in a range including both ends of a range from 4.0 mm to 9 mm,
wherein a width in a horizontal plane of the outer peripheral surface is in a range including both ends of a range from 5.0 mm to 10 mm,
wherein a thickness of a wall formed by the outer peripheral surface and the inner peripheral surface is at least 0.5 mm,
wherein a height of the dental abutment construction member is in a range including both ends of a range from 2 mm to 10 mm,
wherein the dental abutment construction member is a member that reinforces the cervical portion, and
wherein the dental abutment construction member is a member that is used to be embedded in a composite resin such that the dental abutment construction member is not in contact with a tooth substance inside an abutment construction cavity.

2-29. (canceled)

30. The dental abutment construction member according to claim 1, wherein the dental abutment construction member is formed of a material comprising ceramic.

31. The dental abutment construction member according to claim 30, wherein the ceramic comprises a material selected from the group consisting of alumina-toughened zirconia, ceria-stabilized alumina-toughened zirconia, 3 mol % yttria-partially stabilized zirconia, 4 mol % yttria-partially stabilized zirconia, 5 mol % yttria-partially stabilized zirconia, 6 mol % yttria-partially stabilized zirconia, yttria-partially stabilized zirconia composite, alumina, lithium disilicate, and zirconia-toughened lithium disilicate.

32. The dental abutment construction member according to claim 1, wherein both the outer peripheral surface and the inner peripheral surface are flat surfaces.

33. The dental abutment construction member according to claim 1, wherein the outer peripheral surface is an uneven surface and the inner peripheral surface is a flat surface.

34. The dental abutment construction member according to claim 33, wherein an uneven shape of the uneven surface of the outer peripheral surface is a screw-thread shape.

35. The dental abutment construction member according to claim 1, wherein each of the upper surface and the lower surface has an annular shape,
wherein in between the upper surface and the lower surface, there is an intermediate surface which separates the upper surface and the lower surface,
wherein the outer peripheral surface connects an outer edge of the annular shape of the upper surface and an outer edge of the annular shape of the lower surface, and
wherein the inner peripheral surface connects an inner edge of the annular shape of the upper surface and an edge which the inner peripheral surface and an upper-side surface of the intermediate surface connect, and also connects an inner edge of the annular shape of the lower surface and an edge which the inner peripheral surface and a lower-side surface of the intermediate surface connect.

36. The dental abutment construction member according to claim 35, wherein both the outer peripheral surface and the inner peripheral surface are flat surfaces.

37. The dental abutment construction member according to claim 35, wherein the outer peripheral surface is an uneven surface and the inner peripheral surface is a flat surface.

38. The dental abutment construction member according to claim 37, wherein an uneven shape of the uneven surface of the outer peripheral surface is a screw-thread shape.
